(19) United States
(12) Patent Application Publication
(10) Pub. No.: US 2024/0278148 A1
(43) Pub. Date: Aug. 22, 2024

(54) LIQUID-LIQUID CENTRIFUGAL EXTRACTOR

(71) Applicant: TECHNISCHE UNIVERSITÄT WIEN, Wien (AT)

(72) Inventors: Bahram HADDADI, Wien (AT); Matthias GOLDA, Wien (AT); Christian JORDAN, Wien (AT); Michael HARASEK, Wien (AT)

(21) Appl. No.: 18/571,387

(22) PCT Filed: Jun. 24, 2022
(86) PCT No.: PCT/AT2022/060215

§ 371 Date: Dec. 18, 2023

(30) Foreign Application Priority Data
Jun. 24, 2021 (AT) A 50518/2021

(51) Int. Cl. B01D 11/04; B04B 5/12

(52) U.S. Cl. CPC B01D 11/0457; B04B 5/12

(57) ABSTRACT

A liquid-liquid centrifugal extractor, including a shaft, a first mixing chamber with at least one first inlet for a first and a second liquid, the first and the second liquid being mixed by rotating the shaft, a separator mounted on the shaft for separating the first from the second liquid, a first collecting chamber for extracting one of the first and second liquid, wherein the first mixing chamber extends along a first axial section of the shaft and the separator extends along a second axial section of the shaft, the second axial section of the shaft being spaced from the first axial section in axial direction of the shaft.

The invention is concerned with a liquid-liquid centrifugal extractor, comprising:
a shaft,
a first mixing chamber with at least one first inlet for a first and a second liquid, the first and the second liquid being mixed by rotating the shaft,
a separator mounted on the shaft for separating the first from the second liquid,
a first collecting chamber for extracting one of the first and second liquid.

Furthermore, the invention is concerned with a method of liquid-liquid centrifugal extraction, comprising the steps of:
rotating a shaft,
introducing a first and a second liquid into a first mixing chamber,
mixing the first and second liquid inside the first mixing chamber by rotating the shaft,
separating the first from the second liquid by means of a separator mounted on the shaft,
extracting one of the first and second liquid from a first collecting chamber.

The prior art includes DE 3202294 C1, US 2002/134704 A1, US 2004/241062 A1, CN 209438114 U, CN 203842347 U, CN 211635315 U, CN 2097677 U und SU967506 A1.

In a known design of liquid-liquid centrifugal extractors, see e.g. JPH05123502A, two immiscible liquids of different densities are fed to separate inlets and are intensely mixed in an annular mixing space between a spinning rotor and a stationary housing. This creates small droplets with big surfaces to allow easy mass transfer from one liquid into another. In particular, a valuable component may be transferred from an aqueous phase into an organic phase. Inside the rotor, the liquids are separated into a heavy and a light phase by their respective densities. The mixed phases are rapidly accelerated to rotor speed and separation by centrifugal force begins as the liquids are displaced upward. However, arranging the mixing space around the rotor has a number of drawbacks. First, the mixing is caused by the shear stress between the rotating drum and stationary wall, therefore the mixing can be regulated just through the rotational speed of the inner drum, i.e. in case of a need for stronger mixing. Second, multi-stage mixing and extraction is not possible with this design, since there is just one region between the rotor and the outer wall where mixing can happen. Third, with no internal structure in the separation section, back mixing cannot be reliably controlled.

In another design of liquid-liquid centrifugal extractors, a pre-mixed dispersion is fed to the rotor. This, however, requires a separate mixing device. Using multiple devices increases the number of involved components in operation i.e. piping and pumps and also controlling overhead, i.e. sensors and electronics. More components involved increases the initial and maintenance costs.

This problem is solved with the liquid-liquid centrifugal extractor of claim 1 and the method of claim 16. Preferred embodiments are contained in the dependent claims.

In the liquid-liquid centrifugal extractor of the invention, the first mixing chamber extends along a first axial section of the shaft and the separator extends along a second axial section of the shaft, the second axial section of the shaft being spaced from the first axial section in axial direction of the shaft.

Accordingly, in the method of liquid-liquid centrifugal extraction of the invention, the mixing of the first and second liquid inside the first mixing chamber is carried out along a first axial section of the shaft and the separating of the first from the second liquid with the separator is carried out along a second axial section of the shaft, the second axial section of the shaft being spaced from the first axial section of the shaft.

Thus, in the invention the first mixing chamber and the separator are axially spaced from one another. Different from the prior art, the first mixing chamber does not surround the separator but is arranged at the first axial section of the shaft that continues into the second axial section of the shaft holding the separator. In this way, a compact, axial design is achieved. Furthermore, the mixing of the first and second liquid inside the first mixing chamber is improved. It is made easier to adapt the mixing to a specific application as the first mixing chamber is distinct from the separator.

The first and the second fluid are immiscible and of different densities. In the first mixing chamber, the first and the second liquid are mixed. Thus, a liquid-liquid dispersion, more specifically an emulsion, may be formed in the first mixing chamber. A soluble may be transferred from the first liquid to the second liquid in the first mixing chamber. The first liquid may be a heavy phase and the second liquid may be a light phase. In particular, the first liquid may be a feed solution with a soluble and the second liquid may be a solvent, in particular an organic solvent, for example cyclohexane. The soluble of the first liquid may be a valuable component such as an active pharmaceutical ingredient, a metal, a vitamin, a steroid, a protein, etc. that is extracted out of the feed solution into the organic solvent. The intense mixing in the first mixing chamber forms small droplets with big surfaces to allow easy and fast mass transfer from one liquid into the other. The liquid-liquid centrifugal extractor enables a continuous extraction.

In the liquid-liquid centrifugal extractor, the same shaft powers the mixing of the first and second liquid in the first mixing chamber and the separation of the first and second liquid with the separator. Thus, a single drive, in particular an electric motor, may be used to rotate the shaft. This distinguishes the liquid-liquid centrifugal extractor from other designs in which the mixing and the separating of the first and second liquid is done separately, with individual motors and shafts.

For the purposes of this disclosure, all directions and positions, such as “axial”, “radial”, and “circumferential”, are given with respect to the rotational axis of the shaft. Thus, “axial” means in direction of the rotational axis of the shaft.

In a preferred embodiment, the first mixing chamber extends around the first axial section of the shaft.

In a first embodiment, first mixing chamber adjoins the circumferential surface of the shaft. In this case, the mixture of the first and second liquid inside the mixing chamber is in contact with the, preferably cylindrical, circumferential surface of the shaft. As the shaft rotates, the liquid-liquid mixture is subjected to shear forces that facilitate the mixing process.

For further improving the formation of the liquid-liquid dispersion, a first mixing member may be mounted on the shaft at the first axial section thereof inside the first mixing chamber. The first mixing member may project outward from the circumferential surface of the shaft. Preferably, the first mixing member has at least one mixing fin projecting outward from the axis of rotation of the shaft. For example, the mixing fin may project radially outward from the shaft and may extend axially. The first mixing member may also have a sleeve part that surrounds the shaft at the first axial section thereof. The mixing fin may be connected to the sleeve part.

In a preferred embodiment, the separator has a screw member mounted on the shaft at the second axial section thereof. The screw member rotates with the shaft. This embodiment helps prevent back mixing of the first and second liquid when the centrifugal forces concentrate the heavier liquid of the first and second liquid at a radially outer region and the lighter liquid of the first and second liquid at a radially inner region of the separator. The screw member may have a helical element and a tubular element containing the helical element. The mixture follows the spiral flow path of the helical element.

In a preferred embodiment, the first collecting chamber circumferentially surrounds the separator, a first outlet of the separator being in fluid connection with the first collecting chamber. Thus, one of the first and second liquid separated from the other of the first and second liquid passes through the first outlet into the first collecting chamber that preferably fully contains the separator in the inside. This embodiment achieves a compact design. Furthermore, the rotation of the separator is lubricated by the first or second liquid present inside the first collecting chamber.

In a preferred embodiment, the first collecting chamber has a first exit opening. A first controller, for example having a valve and/or a mass/volume flow device, may be provided for regulating the flow rate through the first exit opening. A first sensor, for example a first refraction sensor, may be provided for monitoring the outflow for checking a purity of the liquid. The first sensor may be connected to the first controller so that the measurements of the first sensor can be used as an input to the first controller for regulating the flow rate through the first exit opening.

The liquid-liquid centrifugal extractor preferably comprises a second collecting chamber for extracting the other of the first and second liquid. In this embodiment, both the first and second liquid may be separately withdrawn from the liquid-liquid centrifugal extractor.

In a preferred embodiment, the second collecting chamber has a second exit opening. A second controller, for example having a valve and/or a mass/volume flow device, may be provided for regulating the flow rate through the second exit opening. A second sensor, for example a second refraction sensor, may be provided for monitoring the outflow for checking a purity of the liquid. The second sensor may be connected to the second controller so that the measurements of the second sensor can be used as an input to the second controller for regulating the flow rate through the second exit opening.

In a preferred embodiment, the second collecting chamber adjoins the first collecting chamber in axial direction of the shaft.

In a preferred embodiment, a housing circumferentially delimits the first mixing chamber and the first collecting chamber, preferably also the second collecting chamber. The housing may be stationary. Thus, the housing does not rotate with the shaft.

The first mixing chamber and the first collecting chamber, preferably also the second collecting chamber, are contained inside the common housing. The housing may also contain at least one bearing for rotatably mounting the shaft. Preferably, this at least one bearing is sealed in order to seal off two adjacent chambers, for example the first mixing chamber from the first collecting chamber in a single-stage design or from the second mixing chamber in an (at least) two-stage-design, as described in further detail below, and the second collecting chamber from the first collecting chamber.

Preferably, the first mixing chamber extends from the circumferential surface of the shaft (or the first mixing member mounted on the shaft) to the inside of the housing. The first collecting chamber may be formed by the space between the outside of the separator and the inside of the housing.

The liquid-liquid centrifugal extractor may have a single-stage design with a single first mixing chamber, a single separator, a single first collecting chamber and preferably a single second collecting chamber.

On the other hand, the liquid-liquid centrifugal extractor may have a multi-stage design with at least two stages for the mixing of the first and second liquid and/or at least two stages for the separation of the first and second liquid.

In an embodiment, the liquid-liquid centrifugal extractor comprises a second mixing chamber with at least one second inlet for the first and/or the second liquid, the mixture of the first and second liquid from the first mixing chamber being mixed with the first and/or second liquid introduced into the second mixing chamber by rotating the shaft. The first and second liquid to be mixed enter the first mixing chamber through the at least one first inlet. The mixture is then transferred to the second mixing chamber. More of the first or second liquid can be introduced through the second inlet. The first and second liquid are further mixed in the second mixing chamber. This mixture may then be transferred to the separator.

In another embodiment, the liquid-liquid centrifugal extractor may have at least one further separator. This further separator may be designed as the first separator described above. The separator may be arranged axially between the first and the second mixing chamber. The second mixing chamber may be arranged axially between the separator and the further separator. Of course, the liquid-liquid centrifugal extractor may have further mixing and separation stages. Thus, the liquid-liquid centrifugal extractor may have at least two mixing stages (defined by the first and the second mixing chamber) and/or at least two separation stages (defined by the separator and the further separator). All of the mixing and separation stages may be mounted on the same shaft with the separation stages and the mixing stages being alternately arranged in axial direction. In an embodiment, the first and second fluid are mixed in the first mixing stage and are then separated in the first separation stage. The separated fluid from the first separation stage is guided into the second mixing stage for further mixing with additional first and/or second liquid. This mixture may be separated in the second separation stage.

A second mixing member may be mounted on the shaft in the second mixing chamber. This second mixing member may be designed as the first mixing member described above.

For facilitating the transfer of the mixed first and second liquid from the first to the second mixing chamber, the first and second mixing chamber may be separated by a wall with through openings, e.g. a porous or perforated wall.

The liquid-liquid centrifugal extractor may have further stages, for example three, four or five stages, each having a further mixing chamber and a further inlet.

For maintaining an advantageous axial design of the liquid-liquid centrifugal extractor, the second mixing chamber preferably extends along a third axial section of the shaft, the third axial section of the shaft being axially arranged between the first and the second axial section of the shaft.

For facilitating the transfer of the emulsion from the first mixing chamber (or from the second mixing chamber in a two-stage mixing design) into the separator, the shaft preferably is a hollow shaft, the hollow shaft having a first through hole at the first axial section or at the third axial section, the mixture of the first and second liquid being introduced into the hollow shaft through the first through hole, the hollow shaft having a second through-hole at the second axial section, the mixture of the first and second liquid entering the separator through the second through hole. In a single-stage design, the first through hole may be arranged at the first axial section inside the first mixing chamber. In a two-stage design, the first through hole may be arranged at the third axial section inside the second mixing member. In any multiple-stage design, the first through hole may be arranged inside the last mixing chamber preceding the separator.

In a preferred embodiment, the hollow shaft has a third through hole at the second axial section, one of the first and second liquid exiting the separator through the third through hole of the hollow shaft.

For preventing the mixed first and second liquid to enter the second collecting chamber bypassing the separator, the hollow shaft preferably has an internal blocking member axially arranged between the second and third through hole of the hollow shaft. The blocking member closes off the stream of liquid through the hollow shaft.

In a preferred embodiment, the third through-hole of the hollow shaft is in fluid connection with the second collecting chamber. For this purpose, the shaft may extend into the second collecting chamber.

In a preferred embodiment, the first mixing chamber and/or the separator and/or the first and/or the second collecting chamber are rotation-symmetric about the rotational axis of the shaft.

The invention will be further explained with respect to exemplary embodiments as shown in the drawings.

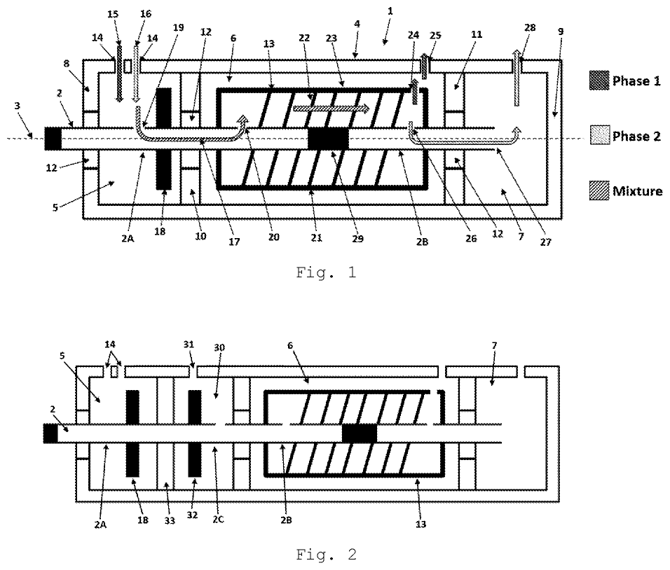

FIG. 1 is a schematic cross-sectional view of a single stage liquid-liquid centrifugal extractor according to the invention.

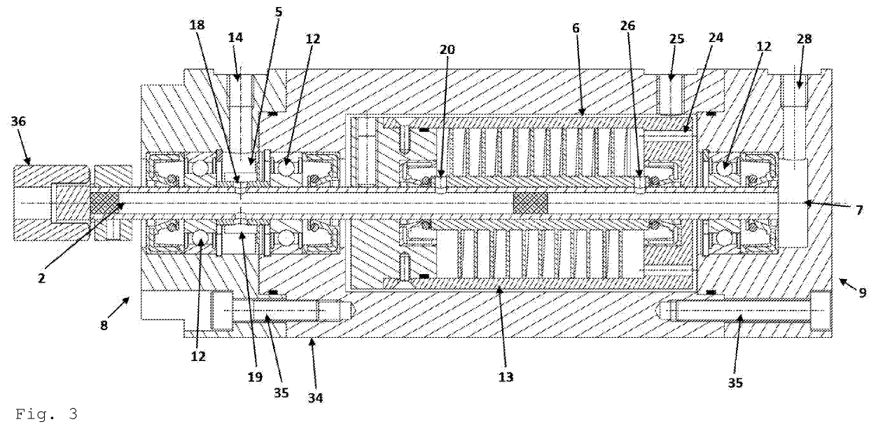

FIG. 2 is a schematic cross-sectional view of a multi-stage mixing liquid-liquid centrifugal extractor according to the invention.

FIG. 3 is a cross-sectional view of a detailed embodiment of the liquid-liquid centrifugal extractor.

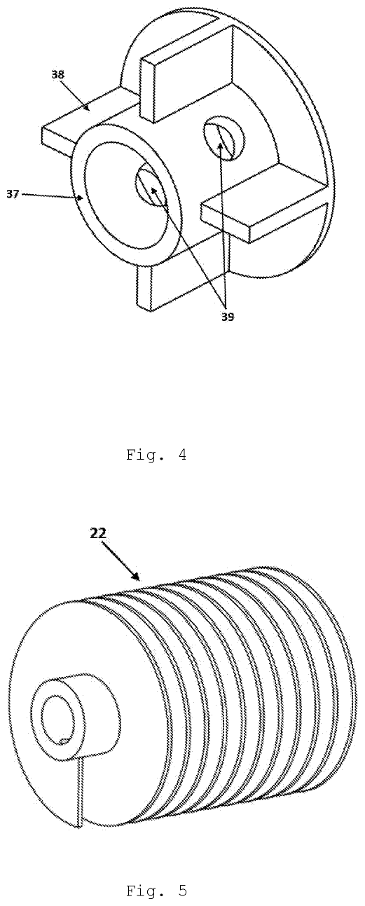

FIG. 4 shows a first mixing member of the liquid-liquid centrifugal extractor of FIG. 3.

FIG. 5 shows a helical element of the separator of the liquid-liquid centrifugal extractor of FIG. 3.

FIG. 1 shows a liquid-liquid centrifugal extractor 1 with a shaft 2 rotating about a rotation axis 3. The shaft 2 is coupled to a drive, in particular an electric motor (not shown). The liquid-liquid centrifugal extractor 1 has a stationary housing 4 that does not rotate with the shaft 2. The housing 4 surrounds a first mixing chamber 5, a first collecting chamber 6 and a second collecting chamber 7. The shaft 2 extends through the first mixing chamber 5, first collecting chamber 6 into the second collecting chamber 7. The housing 4 has a first end part 8 and a second end part 9, each arranged perpendicularly to the rotational axis 3 and defining the axial end regions of the housing 4. A first wall 10 separates the first mixing chamber 5 from the first collecting chamber 6. A second wall 11 separates the first collecting chamber 6 from the second collecting chamber 7. In the shown example, each of the first end part 8, first wall 10 and second wall 11 has a bearing 12 for the shaft 2. A separator 13 is mounted on the shaft 2, as will be further explained below.

The first mixing chamber 5 has at least one first inlet 14 for introducing a first liquid (“Phase 1”) and a second liquid (“Phase 2”), respectively, into the first mixing chamber 5. In the shown example, two separate first inlets 14 are in fluid connection with the first mixing chamber 5. The first liquid is introduced through the one of the two first inlets 14 (see arrow 15 in FIG. 1), while the second liquid is introduced through the other of the two first inlets 14 (see arrow 16 in FIG. 1). Inside the first mixing chamber 5, the first and the second liquid are mixed by rotating the shaft 2 thus creating a mixture of the first and second liquid (see arrow 17 in FIG. 1). In the shown example, mixing is facilitated by means of a first mixing member 18 mounted on the shaft 2. The first mixing member 18 rotates with the shaft 2.

The first mixing chamber 5 extends along and around a first axial section 2A of the shaft 2. The separator 13 extends along and around a second axial section 2B of the shaft. The second axial section 2B of the shaft 2 is axially spaced from the first axial section 2A so that there is no axial overlap between the first mixing chamber 5 and the separator 13. The first mixing chamber 5 radially extends outward from the circumferential surface of the shaft 2 at the first axial section 2A. Thus, the first mixing chamber 5 adjoins the shaft 2. The first collecting chamber 6 circumferentially surrounds the separator 13. The second collecting chamber 7 axially adjoins the first collecting chamber 6.

In the shown example, the shaft 2 is a hollow shaft which has a first through hole 19 at the first axial section 2A. The mixture of the first and second liquid is introduced into the hollow shaft through the first through hole 19. The hollow shaft has a second through-hole 20 at the second axial section 2B. The mixture of the first and second liquid is introduced into the separator 13 through the second through hole 20.

In the shown example, the separator 13 has a screw member 21 mounted on the shaft 2 at the second axial section 2B thereof. The screw member 21 has a helical element 22 inside a tubular element 23. A first outlet 24 formed in the tubular element 23 of the separator 13 at the circumference or at the end part of the tubular element 23, is in fluid connection with the first collecting chamber 6. The first liquid (“Phase 1”) exits the separator 13 through the first outlet 24 and enters the first collecting chamber 6. A first exit opening 25 is formed in the housing 4 delimiting the first collecting chamber 6 to withdraw the first liquid from the first collecting chamber 6. The hollow shaft has a third through hole 26 at the second axial section 2B, axially spaced from the second through hole 20. The second liquid (“Phase 2”) exits the separator 13 through the third through hole 26 of the hollow shaft. This second liquid is then passed into the second collecting chamber 7 through an open end 27 of the shaft 2 (or a hole) extending into the second collecting chamber 7. A second exit opening 28 is formed in the housing 4 delimiting the second collecting chamber 7 to withdraw the second liquid from the second collecting chamber 7.

The second through hole 20 and the third through hole 26 of the shaft 2 are arranged at opposite axial ends of the screw member 21. The hollow shaft has an internal blocking member 29 axially arranged between the second through hole 20 and the third through hole 26 of the hollow shaft.

The liquid-liquid centrifugal extractor 1 of FIG. 1 functions as follows.

The first liquid, which is the heavy phase (“Phase 1”), and the second liquid, which is the light phase (“Phase 2), enter the first mixing chamber 5 through two separate first inlets 14. The drive (not shown) rotates the shaft 2 about its rotational axis 3 which itself rotates the first mixing member 18 fixed to the shaft 2. The first and second liquid are intensely mixed, creating a mixture that is introduced into the hollow shaft through the first through hole 18. The mixture is passed into the separator 13 through the second through hole 20 of the shaft 2 and follows the spiral flow path of the helical element 22 of the screw member 21. The first liquid is concentrated at the radially outer end of the helical element 22, while the second liquid is concentrated at the radially inner end of the helical element 22. Thus, the first liquid flows from the separator 13 through the first outlet 24 into the first collecting chamber 6 and exits the housing 4 through first exit opening 25. On the other hand, the second liquid is passed from the separator 13 through the third through hole 26 into the interior of the hollow shaft and flows in axial direction through open end 27 into the second collecting chamber 7. The second liquid exits the second collecting chamber 7 through the second exit opening 28.

FIG. 2 shows a two-stage mixing liquid-liquid centrifugal extractor 1. In this embodiment, a second mixing chamber 30 extends along and around a third axial section 20 of the shaft 2. The third axial section 2C of the shaft 2 is axially arranged between the first 2A and the second axial section 2B of the shaft 2. The second mixing chamber 30 has a second inlet 31 for introducing the first or the second liquid into the second mixing chamber 30. A second mixing member 32 is mounted on the shaft 2 at the third axial section 2C. The mixture of the first and the second liquid as obtained from the first mixing chamber 1 is mixed with the first or second liquid introduced into the second mixing chamber 30 by rotating the shaft 2. In the shown example, the first mixing chamber 5 and the second mixing chamber 30 are separated by a porous or perforated wall 33.

FIGS. 3 to 5 show a detailed embodiment of a single-stage liquid-liquid centrifugal extractor (as schematically shown in FIG. 1).

In this example, the first end part 8 and the second end part 9 are connected to a main body 34, for example by means of screws 35. The shaft 2 connects to a coupling 36 that may be coupled to the electric motor. The bearings 12 for the shaft 2 may be ball bearings. In the shown example, a single first inlet 14 is used for introducing both the first and second liquid into the first mixing chamber 5. The first inlet 14 may be formed by a borehole extending radially through the housing 4. The first mixing member 18, as shown in greater detail in FIG. 4, has a sleeve part 37 mounted on the shaft 2 and mixing fins 38 radially protruding from the sleeve part 37. Two through openings 39 are formed in the sleeve part 37 which are arranged at the positions of two first through holes 19 for passing the mixture of the first and second liquid into the interior of the hollow shaft 2. As explained above, this mixture enters the separator 13 through second through hole 20. The separator 13 formed by the screw member 21 has the helical element 22 shown in greater detail in FIG. 5.

The helical element 22 is contained inside the tubular element 23 such that the mixture must follow the wounded flow path of the helical element 22. By means of centrifugal forces, the first and second liquid are separated from each other when flowing along the helical element 22 of the separator 13. The first (heavier) liquid is passed into the first collecting chamber 6 through the first outlet 24 and exits the first collecting chamber 6 through the first exit opening 25 which extends radially through the housing 4 to the outside. The second (lighter) liquid enters the hollow shaft through third through hole 26, is passed into the second collecting chamber 7 and exits the second collecting chamber 7 through the second exit opening 28 which extends radially through the housing 4 to the outside.

As an exemplary embodiment, the first liquid may be water contaminated with oil while the second liquid may be a solvent such as cyclohexane (or cyclopentane). The two liquid streams are mixed in the first mixing chamber 5 so that the oil is transferred to the solvent to be analyzed in an infrared spectroscope (which cannot perform measurements in the aqueous phase). The mixture stream is then separated using the separator 13. The solvent with the extracted oil may then be analyzed, for example using QCL Infrared Absorbance Spectroscopy.

1. A liquid-liquid centrifugal extractor, comprising:
a shaft;
a first mixing chamber with at least one first inlet for a first and a second liquid, the first and the second liquid being mixed by rotating the shaft;
a separator mounted on the shaft for separating the first from the second liquid;
a first collecting chamber for extracting one of the first and second liquid;
the first mixing chamber extends along a first axial section of the shaft and that the separator extends along a second axial section of the shaft, the second axial section of the shaft being spaced from the first axial section in axial direction of the shaft.

2. The liquid-liquid centrifugal extractor according to claim 1, characterized in that the first mixing chamber extends around the shaft at the first axial section.

3. The liquid-liquid centrifugal extractor according to claim 1, characterized in that a first mixing member is mounted on the shaft at the first axial section thereof inside the first mixing chamber.

4. The liquid-liquid centrifugal extractor according to claim 1, characterized in that the separator has a screw member mounted on the shaft at the second axial section thereof.

5. The liquid-liquid centrifugal extractor according to claim 1, characterized in that the first collecting chamber circumferentially surrounds the separator, a first outlet of the separator being in fluid connection with the first collecting chamber.

6. The liquid-liquid centrifugal extractor according to claim 1, characterized by
a second collecting chamber for extracting the other of the first and second liquid.

7. The liquid-liquid centrifugal extractor according to claim 6, characterized in that the second collecting chamber adjoins the first collecting chamber in axial direction of the shaft.

8. The liquid-liquid centrifugal extractor according to claim 1, characterized by a housing circumferentially delimiting the first mixing chamber and the first collecting chamber, preferably also the second collecting chamber.

9. The liquid-liquid centrifugal extractor according to claim 1, characterized by a second mixing chamber with at least one second in-let for the first and/or the second liquid, the mixture of the first and second liquid from the first mixing chamber being mixed with the first and/or second liquid introduced into the second mixing chamber by rotating the shaft.

10. The liquid-liquid centrifugal extractor according to claim 9, characterized in that the first and second mixing chambers are separated by a wall with through openings, e.g. a porous or perforated wall.

11. The liquid-liquid centrifugal extractor according to claim 9, characterized in that the second mixing chamber extends along a third axial section of the shaft, the third axial section of the shaft being axially arranged between the first and the second axial section of the shaft.

12. The liquid-liquid centrifugal extractor according to claim 1, characterized in that the shaft is a hollow shaft, the hollow shaft having a first through hole at the first axial section or at the third axial section, the mixture of the first and second liquid being introduced into the hollow shaft through the first through hole, the hollow shaft having a second through-hole at the second axial section, the mixture of the first and second liquid entering the separator through the second through hole.

13. The liquid-liquid centrifugal extractor according to claim 12, characterized in that the hollow shaft has a third through hole at the second axial section, one of the first and second liquid exiting the separator through the third through hole of the hollow shaft.

14. The liquid-liquid centrifugal extractor according to claim 13, characterized in that the hollow shaft has an internal blocking member axially arranged between the second and third through hole of the hollow shaft.

15. The liquid-liquid centrifugal extractor according to claim 13, characterized in that the third through-hole of the hollow shaft is in fluid connection with the second collecting chamber.

16. A method of liquid-liquid centrifugal extraction, comprising the steps of:
rotating a shaft;
introducing a first and a second liquid into a first mixing chamber;
mixing the first and second liquid inside the first mixing chamber by rotating the shaft;
separating the first from the second liquid by means of a separator mounted on the shaft;
extracting one of the first and second liquid from a first collecting chamber;
the mixing of the first and second liquid inside the first mixing chamber is carried out along a first axial section of the shaft and the separating of the first from the second liquid with the separator is carried out along a second axial section of the shaft, the second axial section of the shaft being spaced from the first axial section in axial direction of the shaft.
